(19) United States
(12) Patent Application Publication
(10) Pub. No.: US 2005/0262219 A1
(43) Pub. Date: Nov. 24, 2005

(54) System and method for implementing web services for remote portlets

(75) Inventors: Subbu Allamaraju, Longmont, CO (US); Robert Bergman, Denver, CO (US); Sameer Sawant, Boulder, CO (US); John Michael Bimson, Longmont, CO (US)

Correspondence Address: FLIESLER MEYER, LLP, FOUR EMBARCADERO CENTER, SUITE 400, SAN FRANCISCO, CA, 94111, US

(73) Assignee: BEA Systems, Inc., San Jose, CA (US)

(21) Appl. No.: 11/129,876

(22) Filed: May 16, 2005

Related U.S. Application Data
(60) Provisional application No. 60/572,059, filed on May 18, 2004.

(51) Int. Cl. G06F 15/16

(52) U.S. Cl. 709/217

(57) ABSTRACT

A web services system enables web servers to serve pages that utilize remote portlets. A consumer system serves pages that utilize remote portlets stored on one or more producer systems. When a user accesses a page utilizing a remote portlet, the consumer system contacts the producer system, obtains content for the page and presents the page to the user. One or more URLs may be rewritten to reflect differences between the consumer system and the producer system.

### CLAIM OF PRIORITY

This application claims the benefit of:
U.S. Provisional Patent Application 60/572,059 entitled SYSTEM AND METHOD FOR IMPLEMENTING WEB SERVICES FOR REMOTE PORTLETS, by Subbu Allamaraju et al., filed May 18, 2004, the entire contents of which is incorporated herein by reference.

### CROSS REFERENCE TO RELATED APPLICATIONS

The following commonly owned, co-pending United States Patents and Patent Applications, including the present application, are related to each other. Each of the other patents/applications are incorporated by reference herein in its entirety:
U.S. patent application Ser. No. ______, entitled SYSTEM AND METHOD FOR IMPLEMENTING AUTHENTICATION WEB SERVICES FOR REMOTE PORTLETS, by Subbu Allamaraju et al., filed on May ______, 2005, Attorney Docket No. BEAS 1615US1; and
U.S. patent application Ser. No. ______ entitled SYSTEM AND METHOD FOR IMPLEMENTING WEB SERVICES FOR REMOTE PORTLETS, by Subbu Allamaraju et al., filed on May ______, 2005, Attorney Docket No. BEAS 1626US1.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates broadly to the delivery of web portal content. The present invention relates more particularly to implementing web services for remote portlets.

### BACKGROUND OF THE INVENTION

Since its inception in 1995, the Java™ programming language has become increasingly popular. (Java™ is a trademark of Sun Microsystems, Inc.) Java, which is an interpreted language, enabled the creation of applications that could be run on a wide variety of platforms. This ability to function across a variety of different client platforms, i.e., platform independence, and Java's relatively easy implementation of network applications has resulted in its use in endeavors as basic as personal webpages to endeavors as complex as large business-to-business enterprise systems.

As Java has become more commonplace, a wide variety of tools and development platforms have been created to assist developers in the creation and implementation of applications and portals in Java as well as other languages, which provide a way to aggregate content and integrate applications, allowing a visitor to a Web site to access everything via a user interface.

One ongoing need has been the ability for providers of web applications to prepare functional content that can be implemented through outside sites. Often providers will wish to offer web services without setting up the front-end interface elements that are necessary to implement the web services.

The Web Services for Remote Portlets (WSRP) standard by the OASIS group has enabled the delivery of functional applications from producer sites to consumer sites. However, the implementation of WSRP has presented considerable difficulties. For example, current implementations of WSRP require a producer system to have its own local portal architecture to support portlets on remote systems, increasing the difficulty of providing portlets for remote consumer systems. What is needed is a producer architecture that is independent of a local portal system.

### BRIEF DESCRIPTION OF THE DRAWINGS

FIG. 1 is a block diagram illustrating an overview of the interaction between a consumer system, user systems, and producer systems in an embodiment.

FIG. 2 is a block diagram illustrating a more detailed view of a consumer and a producer in an embodiment.

FIG. 3 illustrates one embodiment of an authentication and authorization process in an embodiment.

FIG. 4 is a flow chart illustrating one embodiment of a process for implementing a remote portlet in an embodiment.

### DETAILED DESCRIPTION

In accordance with embodiments, there are provided mechanisms and methods that enable delivery of web services through the use of remotely stored portlets. These mechanisms and methods can enable embodiments to provide consumers, i.e., entities that serve pages that utilize remotely stored portlets, with the capability to serve remotely stored content to users. Users, also called requesters, may be human users, proxies or automated entities that request content from the consumer. Portlets are stored on one or more producer systems, i.e., entities that create and store content. A portlet is a self-contained application that is responsible for rendering its own content on a page. By way of a non-limiting example, a portlet might be a display of current news headlines, wherein if a user selects a headline the portlet retrieves and the underlying story and displays it for the user. Portlets can communicate with other portlets and with back-end processes such as legacy software, databases, content management systems, enterprise business services, etc. In addition, multiple instances of a portlet can execute simultaneously. Portlets can be defined by an extensible Markup Language (XML) document defining instructions for the portal.

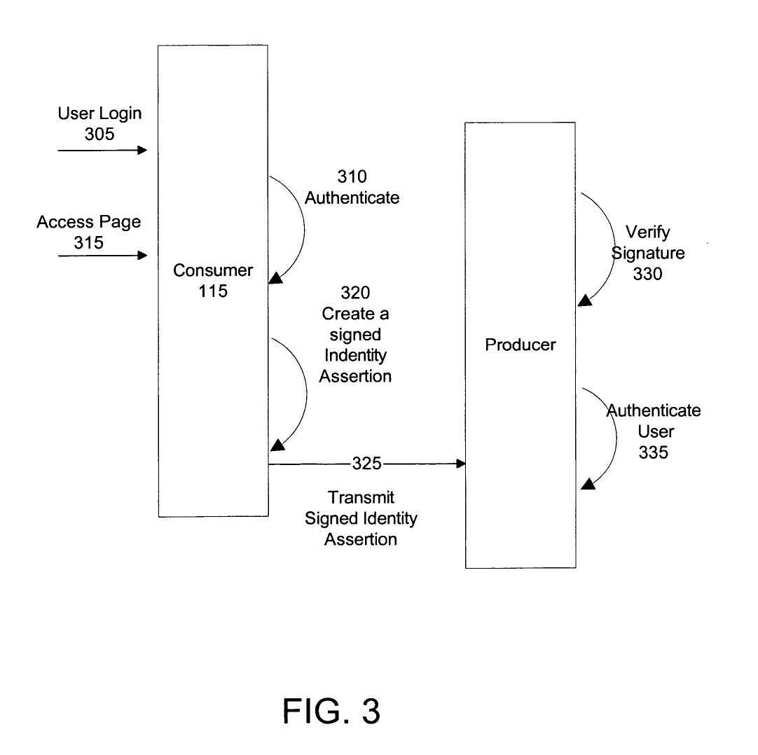

A producer system maintains an architecture that enables local portlets to be utilized remotely independent of the producer system's own portal architecture. A consumer system serves pages that utilize remote portlets stored on one or more producer systems. When a user accesses a page utilizing a remote portlet, the consumer system contacts the producer system, obtains content for the page and presents the page to the user. In an embodiment, one or more URLs may be rewritten by one or both of the consumer system and/or the producer system in order to reflect differences between the consumer system and the producer system. Embodiments providing URL rewriting are described in further detail below with reference to FIG. 3.

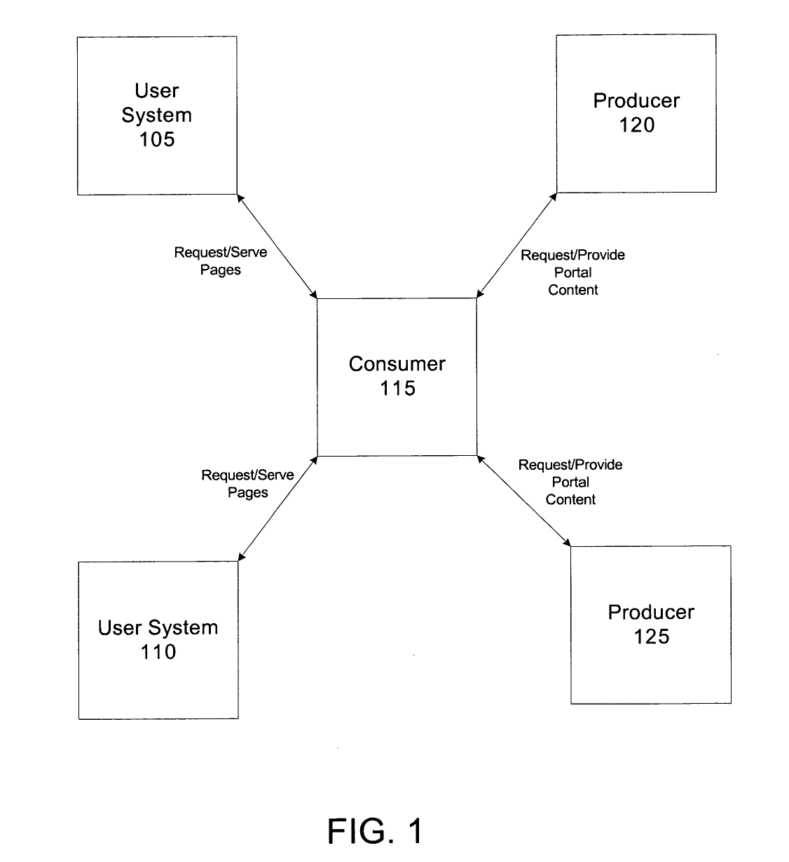

FIG. 1 illustrates an overview of the interaction between a consumer system, user systems, and producer systems in an embodiment. Producer systems 120, 125 store one or more portlet applications that are utilized by user systems 105, 110 through the facilitating actions of a consumer 115. In some embodiments, the producer systems 120, 125 maintain web portals. In alternate embodiments, the producer systems 120, 125 perform other functions or merely serve to provide access to portlets. A remote portlet is a portlet utilized by a page stored on a site remote to the portlet. In an embodiment, the user systems 105, 110 are systems that may be remotely located with respect to the consumer 115 that may be utilized by end users. In some embodiments, user systems 105, 110 comprise web page viewing capabilities.

In an embodiment, the consumer 115 is a network accessible system that serves web pages, content, and applications. The consumer 115 can serve its own content in addition to content stored on the producers 120, 125. The consumer 115 presents a front-end interface to the user systems 105, 110 that utilizes functional applications that may be stored internally and/or on the producers 120, 125. The consumer 115 serves pages that utilize remote portlets on the producers through proxy portlets (not shown) and allow the consumer 115 to utilize the remote portlets' functionality.

During a registration phase, the consumer 115 registers with a producer 120. In an embodiment, the producer 120 identifies each consumer with a unique handle that enables the producer 120 to identify what portlets are available to a particular consumer. In some embodiments, the consumer need not register with the producer 120. The producer provides a service description to the consumer 115 that indicates properties of the producer 120 and lists the available portlets that are stored on the producer 120. The producer 120 also provides a Web Services Description Language (WSDL) file, or the equivalent information in another format, indicating data types and message protocols to be used for interacting with the producer 120. In alternative embodiments, other formats and/or persistence mechanisms may be used to persist the data type and message protocol information.

When a user system 105 establishes contact with the consumer 115, the consumer aggregates pages, and stores proxy portlets in the pages that access remote portlets on the producer 120. The user system 105 can send a page request to the consumer 115 for a page that includes remote portlets that utilize the producer 120. When the consumer 115 receives such a request from the user system 105, the consumer 115 sends a request for the data that appears in the page to the producer 120. The producer 120 returns the data, which the consumer 115 integrates into a single interface and presents to the end user system 105.

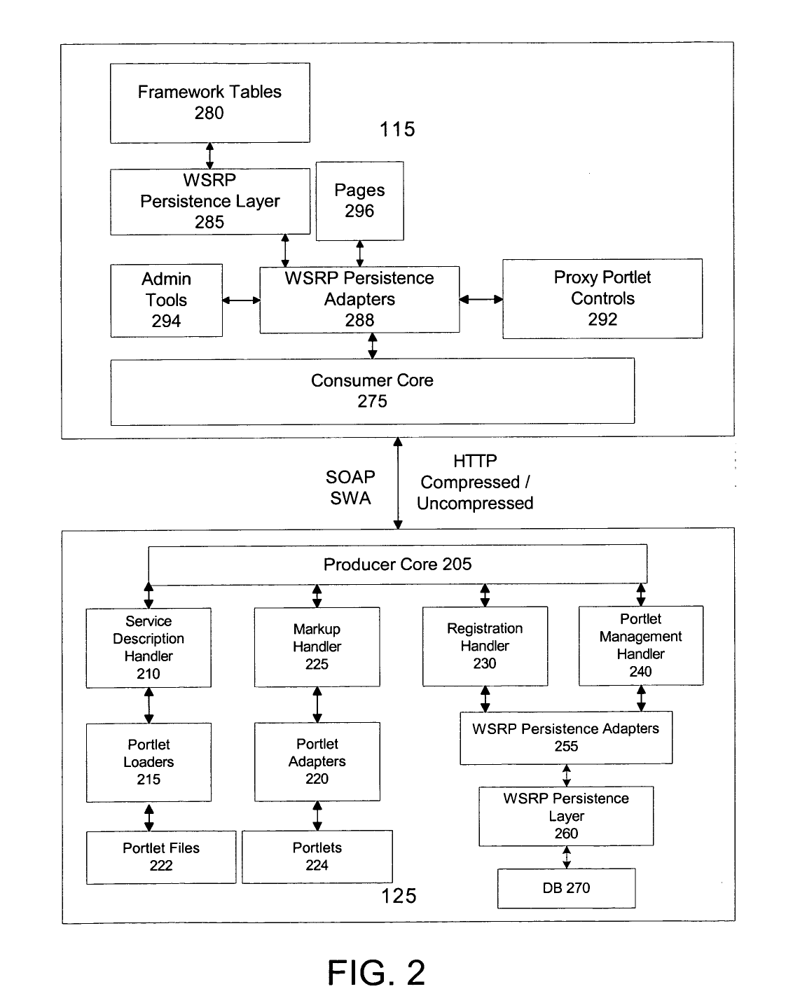

FIG. 2 is a block diagram illustrating a more detailed view of a consumer 115 and a producer 125 in accordance with an embodiment. The producer 125 includes a producer core 205, a service description handler 210, portlet loaders 215, portlet adapters 220, portlet files 222, a markup handler 225, a registration handler 230, a portlet management handler 240, WSRP persistence adapters 255, persistence layers 265, one or more portlets 224, and a database (DB) 270. The infrastructure disclosed herein provides an independent support architecture for portlets that can be utilized remotely without the presence of a local portal.

The producer core 205 is a servlet that is configured to reside on the producer and communicates with the consumer 115. The producer core 205 generates the WSDL files, for example, which indicate the parameters of communication between the producer 125 and the consumer 115, and transmits the files to the consumer 115. These parameters can include data types and messaging protocols and can be preconfigured or user-selected in some embodiments.

The producer 125 additionally includes a service description handler 210. The service description handler 210 is responsible for providing a listing of portlets 224 that are available to consumers. The service description handler 210 utilizes the portlet loaders 215 to load the portlet files 222. The portlet files 222, which define the available portlets, are either portlet files or files created from a deployment descriptor such as a portlet.xml file. In some embodiments, the portlet loaders 215 include separate loaders for different types of portlets such as Java Page Flow (JPF) portlets, Struts portlets, and Java portlets. Struts portlets are portlets that utilize the Struts framework layer from the Apache Software Foundation. JPF portlets are portlets that utilize Page Flows to separate interface content from navigation control and other functional logic. In some embodiments, the JPF portlets on the producer can support nested page flows. Nested page flows are page flows that can be utilized temporarily without discarding a currently executing page flow.

The service description handler 210, through the producer core 205, returns to the consumer 115 a list of available portlets in the form of an array of PortletDefinition classes. The PortletDefinition classes include a portletHandle identifier that identifies the portlet and modes, states, MIME types, a title, and a description for each portlet.

A registration handler 230 registers consumers with the producer 125 so that the consumers can access portlets on the producer 125. The registration process entails the consumer 115 providing certain predetermined identification information to the producer 125. In some embodiments, the producer 125 does not register the consumer 115. The consumer registration information is stored in the database 270 through the persistence adapters 255 and persistence layer 260.

The portlet management handler 240 is responsible for storing, modifying, and retrieving portlet preferences and modifying or deleting portlets. The WSRP persistence adapters 255 are configured to receive requests to generate, modify, and read information stored in the database 270 from the registration handler 230 and portlet management handler 240. In one embodiment, the WSRP persistence adapters 255 include separate adapters for the registration handler 230 and the portlet management handler 240. The persistence layer 260 manages access to the database 270, including representing data in the database 270 as objects, and allowing particular data types to be accessed as such without requiring that the accessing entity have any knowledge about how the data is stored in the database 270. When a request to modify data, such as modifying the registration information of a consumer for example, is received from the registration handler 230 through its persistence adapter 255, the persistence layer 260 receives the request in the form of an object modification request. The persistence layer 260 locates the various instances in the database 270 associated with the registration information and modifies them appropriately.

The markup handler 225 is responsible for processing markup requests for the portlets 224. When a request from a user system is received at the consumer, for example, a page is loaded that utilizes a remote portlet, the consumer 115 requests the appropriate render data from the producer. This request includes an identity of the portlet and a listing of capabilities of the user system. The markup handler 225 receives this request and determines an appropriate portlet adapter 220 to access the referenced portlet. The portlet adapters 220 are adapters that enable portlets 224 to be accessed as remote portlets. The portlet adapters 220 can include portlet adapters for multiple portlet types, such as JPF, Java, and Struts portlets. In some embodiments, a portlet adapter 220 can comprise a JAR file that is inserted into a producer to enable it to interact with remote consumers in a manner similar to how the portlet would interact with a local portal.

The consumer 115 includes a consumer core 275 that manages communication with the producer 125, one or more persistence adapters 288, administration tools 294, proxy portlet controls 292, a WSRP persistence layer 285, pages 296 that reference the remote portlets 224 through included proxy portlets, and framework tables 280.

The consumer core 275 communicates with the producer core 205 using the Simple Object Access Protocol (SOAP). In some embodiments, the consumer and producer cores use a variant of SOAP, known as SOAP With Attachments (SWA) that enables binary files to be attached to SOAP messages. In some embodiments, the producer and consumer use HyperText Transport Protocol (HTTP) compression to reduce the size of transmitted data. The consumer core 275 receives a WSDL file from the producer 125 that it uses to configure its interaction with the producer 125.

The framework tables 280 store information about the portlets available on the producer 125 and other portlets, which is received from the service handler 210 of the producers. This information includes identifying information for the portlets, identifying information for the producer 125, capacities of the producer 125, and the types of functionality provided by the portlets. The framework table 280 also includes information about instances of proxy portlets stored on the consumer 115. When a portlet is first identified during registration/discovery a proxy portlet control 292 is created for the proxy that can be used to configure how the proxy is utilized on the consumer side.

A set of administration tools 294 enable a user or administrator of the consumer 115 to create pages 296 that access the remote portlets 224 on the producer. The administrative tools 294 insert a proxy portlet associated with a remote portlet on the producer into a created page 296 in a location that would normally store a local portlet.

A persistence layer 285 enables the administrative tools 296 and the proxy portlet controls 292 to store information about proxy portlet instances, including configuration information through their respective persistence adapters 288. This information can be retrieved, created, or modified by submitting actions to be performed on data objects to the persistence layer 285. The persistence layer 285 receives the actions, locates the data corresponding to the objects on the framework tables 280 and retrieves and/or modifies the tables accordingly.

When a user attempts to view a page 296 on the consumer 115 that includes one of the remote portlets 224, the consumer transmits a GetMarkup request to the producer 125 to obtain the rendered content that should appear in the page. The request includes a handle for the portlet and capabilities of the client on the user system 105. The producer 125 utilizes one of the portlet adapters 220 to obtain the rendered content for the page from the portlet and returns the content to the consumer 115, which presents the rendered page to the user.

If a user initiates an interaction with a page utilizing a remote portlet, for example by submitting a form, the consumer 115 sends to the producer 125 the handle for the portlet, the form data storing the information stored on the form, query data indicating a requested response from the portlet, and any uploaded information. The producer 125 utilizes one of the portlet adapters 220 to submit this information to the portlet as if it had been submitted locally to the portlet. The portlet processes the request and changes its current mode/window state in response. The mode/window state indicates a state/mode for the window displaying the portlet, such as minimized, maximized, hidden, or normal.

The producer then returns to the consumer 115 the new window state and a new navigational state indicating a new page to be rendered on the main page on the consumer 115. When the consumer 115 subsequently requests markup, this new page, which includes the response to the submitted form, is displayed inside the viewed portal page 296 on the consumer.

The producer system 125 utilizes templates for various types of Uniform Resource Locators (URLs). The templates include embedded fields for different types of information to be provided by the producer or consumer. When URLs are passed between the producer and the consumer, they may be rewritten by the consumer or producer to reflect differences in how the URLs would be accessed from either system. For example, URL designed to be utilized by the producer might not include the domain of the producer and would only include a location in a local file system. The consumer could rewrite such a URL with a global address that included the domain of the producer. Alternatively, when the consumer submits a markup request to the producer, it embeds blank fields into the URL for information such as markup state, window state, interaction state, and other information. The producer then rewrites the URL with this information included.

In an embodiment and by way of example, an action URL:
wsrp_rewrite?wsrp-urlType=blockingAction&wsrp-secureURL=false&wsrp-mode=wsrp:view&wsrp-windowsState=wsrp:normal&wsrp-interationState=blahblah/wsrp_rewrite
   may be rewritten by a consumer as follows:
http://my.domain.com/portal?page=1&wsrp-urlType=blockingAction& mode=wsrp:view& state=wsrp:normal&wsrp interationState=blahblah

In an embodiment and by way of example, a resource URL:
Wsrp-rewrite?wsrp-urlType=resource&wsrp-secureURL=false&wsrp-url=/pics/logo.gif/wsrp_rewrite
   may be rewritten by a consumer as follows:
http://my.domain.com/proxy?wsrp-url=http://blah.com/pics/logo.gif&wsrp-requiresRewrite=false

In some embodiments, page flow portlets and struts portlets can interact directly with a user rather than working through the consumer. As mentioned above, the producer utilizes a URL writing framework based on templates. When portlets are interacting directly with a user, one set of templates is used. When portlets interact through a consumer a separate set of templates are used. For example, when a portlet is being accessed directly by a user, a template is used that does not require rewriting by the consumer.

FIG. 3 illustrates one embodiment of an authentication and authorization process. A user login (305) can be submitted to the consumer 115. The login can occur when the user first accesses the consumer 115 or when the user first attempts to access a page. The consumer 115 performs its own authentication (310) of the user to verify the user's identity. While in the present embodiment, a username and password are submitted as authentication information; in alternate embodiments other forms of authentication information such as a secure token can be accepted as authentication information.

When the user attempts to access (315) a page that utilizes a remote portlet that includes protected content, the consumer 115 generates a signed identity assertion and transmits it (325) to the producer 125. The signed identity assertion includes a digital signature that is particular to the consumer and indicates the identity of the user for the producer 125. In one embodiment, the signature is transmitted in Security Assertion Markup Language (SAML), however, other equivalent security mechanisms may be used in alternative embodiments. Once the user has been authenticated with the consumer 115, the consumer 115 can send the identity assertion to other producers without the user needing to be re-authenticated by the consumer 115.

The producer, upon receiving the signature, verifies that the signature is valid. The signature's validity can be proven through a password/username included with the signature, a token included with the signature, a public key, or other mechanism. Once the signature is verified, the producer authenticates the user (335).

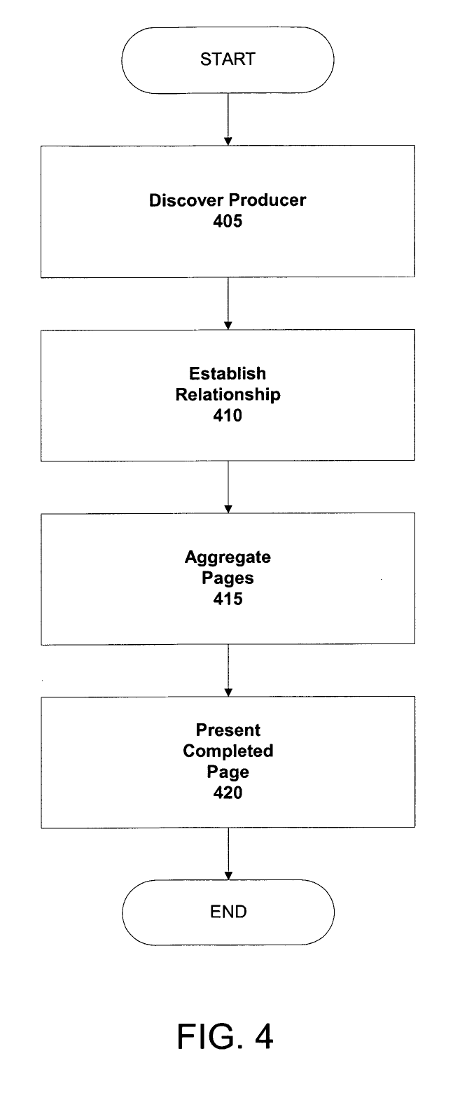

FIG. 4 is a flow chart illustrating one embodiment of a process for implementing a remote portlet. In block (405) the consumer discovers a producer that provides remote portlets to consumer. This discovery can occur at the initiation of the consumer 115 or the producer 125. In block (410) the consumer establishes a relationship with the producer. This entails the consumer registering and providing identification information to the producer and the producer providing a listing of available portlets and the functions performed by the portlets. In some embodiments, the producer 125 does not require registration by the consumer 115.

In block (415) an administrator of the consumer aggregates pages that utilize remote portlets on the producer. Aggregation can be performed by inserting code referencing the remote portlets into web pages. In an alternate embodiment, the consumer system is a host site that enables non-administrators to design web content and the pages are aggregated by a user of the host site.

In block (420) the completed page is presented to an end user. The consumer 115 sends a request for markup to the producer 125, which returns the rendered content to the consumer 115, which then integrates the rendered content into a completed page.

Other features, aspects and objects of the invention can be obtained from a review of the figures and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Obviously, many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention.

1. A method for providing access to a portlet, the method comprising:
storing a page, the page configured to utilize a portlet residing on a remote producer system, the portlet independent of a portal on the producer system;
receiving, from a user system, a request for the page;
requesting render content for the portlet from the producer system in response to the request for the page;
receiving the render content for the portlet; and
presenting the page, including the render content responsive to the request.

2. The method of claim 1, further comprising:
receiving from the user system an interaction request, the interaction request submitted through the page and configured to utilize the remote portlet;
requesting from the remote producer a response for the interaction request; and
presenting the response for the interaction request to the user.

3. The method of claim 1, wherein further comprising:
rewriting at least one URL in the page to reflect differences in how the URLs would be accessed from the producer system.

4. The method of claim 1, wherein the portlet is at least one of a struts portlet and a page flow portlet.

5. The method of claim 1, further comprising:
accepting authentication information from the user; and
submitting an identity assertion to the remote producer.

6. A producer system for providing access to portlets, the producer system comprising:
a producer core module configured to manage access between local portlets that are independent of a local portal and remote consumers;
a plurality of portlets configured to function as applications within web pages;
a plurality of portlet adapters configured to enable the plurality of portlets to function within web pages on remote consumers;
a database storing identification information for consumers; and
a registration handler module configured to receive identification information from the consumer systems and store the identification information in the database.

7. The system of claim 6, wherein the plurality of portlet adapters comprises a URL detection and rewrite module to rewrite at least one URL in at least one page to reflect differences in how the URLs would be accessed from a consumer.

8. The system of claim 6, wherein the plurality of portlet adapters comprises at least one of: a portlet adapter for page flow portlets and a portlet adapter for struts portlets.

9. The system of claim 6, wherein the portlet adapters are configured to utilize Web Services for Remote Portlets (WSRP).

10. The system of claim 6, wherein the producer core module is configured to utilize HyperText Transport Protocol (HTTP) compression.

11. The system of claim 6, wherein the producer core module is configured to utilize Simple object access protocol With Attachments (SWA).

12. A method for enabling remote consumers to utilize portlets, the method comprising:
maintaining a portlet which is independent of a local portal;
adapting the portlet to receive requests from a remote consumer;
receiving a request for markup associated with the portlet from the remote consumer; and
returning markup associated with the portlet to the remote consumer.

13. The method of claim 12, further comprising:
rewriting at least one URL in a page associated with the request for markup to reflect differences in how the URLs would be accessed from a consumer system.

14. The method of claim 12, wherein the portlet is at least one of: a struts portlet and a page flow portlet.

15. The method of claim 12, wherein returning markup associated with the portlet comprises transmitting the markup with HyperText Transport Protocol (HTTP) compression.

16. The method of claim 12, wherein returning markup associated with the portlet comprises transmitting the markup with Simple object access protocol With Attachments (SWA).

17. A machine readable medium comprising machine readable instructions stored thereon that when executed by a processor cause a system to:
maintain a portlet which is independent of a local portal;
adapt the portlet to receive requests from a remote consumer;
receive a request for markup associated with the portlet from the remote consumer; and
return markup associated with the portlet to the remote consumer.

18. The machine readable medium of claim 17, further comprising instructions that when executed by the processor cause the system to rewrite at least one URL in a page associated with the request for markup to reflect differences in how the URLs would be accessed from a consumer system.

19. The machine readable medium of claim 17, wherein the portlet is at least one of a struts portlet and a page flow portlet.

20. The machine readable medium of claim 17, further comprising instructions that when executed by the processor cause the system to transmit the markup with HyperText Transport Protocol (HTTP) compression.

21. The machine readable medium of claim 17, further comprising instructions that when executed by the processor cause the system to transmit the markup with Simple object access protocol With Attachments (SWA).
